(19) United States
(12) Patent Application Publication
(10) Pub. No.: US 2006/0221061 A1
(43) Pub. Date: Oct. 5, 2006

(54) Touch sensor and control with random pulse spacing

(75) Inventor: Charles David Fry, New Bloomfield, PA (US)

Correspondence Address: Robert J. Kapalka;Tyco Electronics Corporation, Suite 140, 4550 New Linden Hill Road, Wilmington, DE, 19808, US

(73) Assignee: Tyco Electronic Corporation

(21) Appl. No.: 11/095,987

(22) Filed: Mar. 31, 2005

(51) Int. Cl. G09G 5/00

(52) U.S. Cl. 345/173

(57) ABSTRACT

A control system for controlling a device includes a touch sensitive interface. The control system also includes a controller configured to communicate with the touch sensitive interface and to detect user manipulation of the touch sensitive interface with a series of non-periodic test pulses and monitored responses thereto, thereby avoiding inaccurate touch detection attributable to synchronous noise in an ambient environment of the control system.

### BACKGROUND OF THE INVENTION

This invention relates generally to touch sensitive control interfaces, and more particularly, to a touch sensitive control interface including compensation for noise and interference in the ambient environment which may otherwise negatively affect operation of the interface and/or the associated device.

Due to their convenience and reliability, touch sensitive control interfaces are increasingly being used in lieu of mechanical switches for various products and devices. Touch sensitive control interfaces are used in a wide variety of exemplary applications such as appliances (e.g., stoves and cooktops), industrial devices such as machine controls, cash registers and check out devices, vending machines, and even toys. The associated device may be finger operated by pressing predefined areas of the interface, and the device typically includes a controller coupled to the interface to operate mechanical and electrical elements of the device in response to user commands entered through the touch control interface.

Various types of touch technologies are available for use in touch control interfaces, including but not limited to touch sensitive elements such as capacitive sensors, membrane switches, and infrared detectors. U.S. Pat. No. 5,760,715, for example, describes capacitive touch sensors which may be used in a touch sensitive control interface. In operation, the capacitive sensor completes a circuit to earth ground when a user's finger is adjacent the sensor. To prevent inadvertent actuation of the interface and the controlled device, the '715 patent describes a verification cycle which attempts to validate actual touches to the interface, and as such the system disregards certain control inputs which cannot be validated or verified.

As described in the '715 patent, a controller causes the touch sensitive sensors to issue a series of test pulses to earth ground on a periodic basis. As such, the controller pulses the touch sensors for inputs and monitors the returns. When a predetermined number of test pulses produce a return, a touch is detected and the controller responds appropriately to operate the controlled device. In other words, returns must be generated for a predetermined period of time before the controller will act on the input. Thus, for example, if one of the sensors is inadvertently activated, for example, while the control interface is being wiped clean, as another example, when a user or passerby unintentionally brushes up against or contacts the control interface, the detected touch will not be sustained for the predetermined number of pulses, and the verification scheme will therefore not be met and the returns will be ignored. While such validation schemes may successfully prevent activation of the device due to accidental or inadvertent control inputs through incidental contact with the control interface, it has been found that such systems are nonetheless susceptible to false control inputs and inadvertent actuation of the device.

More particularly, known touch sensitive elements and systems are particularly disadvantaged in that they may be vulnerable to inadvertent activation attributable to noise and interference, including electromagnetic interference (EMI), in the ambient environment of the system. Such noise and interference may lead to false control inputs and inadvertent actuation of a controlled device, without a user ever contacting the control interface. Synchronous noise and EMI, for example, may occur at a periodic frequency or with harmonics of a periodic frequency that could coincide with the test pulses, and in such circumstances the synchronous noise and EMI may interfere with operation of the control panel and cause a false touch to be detected. On the other hand, non-synchronous noise and EMI events may temporarily affect the response of the system to touches, and at times the system may be much more sensitive than at other times. As a result, the associated device may be influenced, operated or adjusted due to the ambient noise without action or intervention by a person. As such, actual operating conditions, e.g., EMI and noise in the ambient environment of the touch sensor may affect the accuracy, sensitivity, and reliability of the touch sensors, and thus cause inadvertent and unintentional operation of the controlled device.

By way of example, it is possible that EMI or noise attributable to operation of one appliance (e.g., a blender or microwave oven) may influence, activate, or change the control setting of another appliance using the above described verification scheme, such as a nearby coffee maker. As another example, activation of a cellular phone may energize or change an operating setting of a heating element in an oven having a control interface with such a verification scheme, and in such a situation hazardous conditions may be presented. In yet another example, a cellular phone or hand held electronic device may activate a nearby vending machine having a touch control interface and verification scheme, and in such a case may result in financial loss.

Additionally, the pulsing of the touch sensors by the controller may generate excessive conductive and radiated emissions which may interfere with other devices, and consequently the touch sensors may run afoul of Federal Communications Commission (FCC) standards for such devices.

### BRIEF DESCRIPTION OF THE INVENTION

In an exemplary embodiment, a control system for controlling a device is provided. The control system comprises a touch sensitive interface. The control system also includes a controller configured to communicate with the touch sensitive interface and to detect user manipulation of the touch sensitive interface with a series of non-periodic test pulses and monitored responses thereto, thereby avoiding inaccurate touch detection attributable to synchronous noise in an ambient environment of the control system.

In another exemplary embodiment, a control system for controlling a device is provided. The control system comprises a touch sensitive interface. The control system also includes a controller configured to pulse the touch sensitive interface at randomized pulse spacing and conduct a touch detection sequence responsive to the pulses, thereby avoiding inaccurate touch detection attributable to synchronous noise in an ambient environment of the control system.

In yet another exemplary embodiment, a control system for controlling a device is provided. The control system comprises a touch sensitive interface including at least one capacitive touch sensor configured to complete a circuit through earth ground when touched by a user. The control system also includes a controller configured to pulse the touch sensitive interface and conduct a touch detection sequence responsive to the pulses. The pulses are randomly generated to avoid inaccurate touch detection attributable to synchronous noise in an ambient environment of the control system. The controller is further configured to compare a pre-test pulse baseline signal level to a post-test pulse signal level at each touch detection sequence to validate or invalidate a detected touch based upon a difference between pre and post-test pulse signal levels and a current detect threshold.

### BRIEF DESCRIPTION OF THE DRAWINGS

FIG. 1 is a schematic block diagram of an exemplary touch sensitive control system in accordance with an embodiment of the invention.

FIG. 2 is an exemplary control interface which may be used in the control system of FIG. 1.

FIG. 3 is an exemplary graph showing emitted power versus frequency when test pulses are generated at fixed or periodic intervals.

FIG. 4 is an exemplary graph showing emitted power versus frequency when test pulses are generated at non-periodic intervals.

FIG. 5 is a sampling graph exemplifying the generation of test pulses with a constant pulse spacing.

FIG. 6 is a sampling graph exemplifying test pulses generated with non-periodic pulse spacing.

FIGS. 7A-7G illustrate exemplary method flowcharts of an exemplary control algorithm which may be used with the control system shown in FIG. 1.

### DETAILED DESCRIPTION OF THE INVENTION

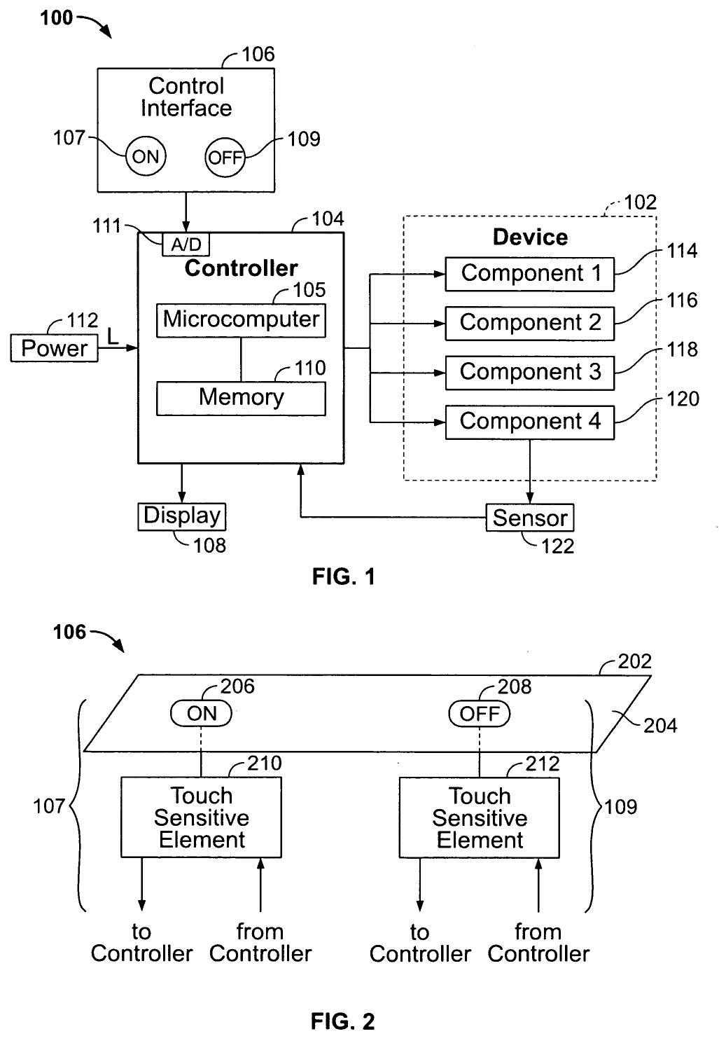

FIG. 1 is a schematic block diagram of an exemplary touch sensitive control system 100 in accordance with an exemplary embodiment of the invention. The control system 100 includes a device 102, a controller 104 operatively coupled to the device 102, and a touch control interface 106 for receiving control inputs for operation of the device 102 via the controller 104. As will be described below, the controller 104 is configured to compensate for EMI interference and noise in the ambient environment which could otherwise undesirably influence, activate, or change the control settings of the controlled device 102. It may therefore be assured that the device 102 is operable only with actual user commands entered through the control interface 106.

In one embodiment, the device 102 is a known vending machine having the touch control interface 106 for operation thereof. In other alternative embodiments, the device 102 may be an appliance, an industrial machine, a toy, or another device in which a touch sensitive control interface 106 is desirable, and for which inadvertent actuation of the device 102 is a concern.

In an exemplary embodiment, the controller 104 may include a microcomputer or microprocessor 105 and a controller memory 110. The controller 104 is coupled to the user control interface 106 in a known manner, and the control interface 106 includes one or more touch sensitive elements or touch sensors, e.g. touch sensors 107 and 109. Analog signals may be received and converted at the controller 104 by an A/D converter 111. An operator may enter control parameters, instructions, or commands and select desired operating algorithms and features of the device 102 via the control interface 106.

In one embodiment a display 108 is coupled to the controller 104 to display appropriate messages and/or indicators to the operator of the device 102 to confirm user inputs and operation of the device 102. The controller memory 110 stores instructions, calibration constants, and other information as required to satisfactorily complete a selected user instruction or input. The memory 110 may, for example, be a random access memory (RAM). In alternative embodiments, other forms of memory could be used in conjunction with RAM memory, including but not limited to flash memory (FLASH), programmable read only memory (PROM), and electronically erasable programmable read only memory (EEPROM).

Power to control the system 100 is supplied to the controller 104 by a power supply 112 configured to be coupled to a power line L. Analog to digital and digital to analog converters are coupled to the controller 104 to implement controller inputs and executable instructions to generate controller outputs to operative components 114, 116, 118 and 120 of the device 102 according to known methods. Although the four components 114, 116, 118, and 120 are illustrated in FIG. 1, greater or fewer components may be employed in alternative embodiments.

In response to user manipulation of the control interface 106, the controller 104 monitors various operational factors of the device 102 with one or more transducers or monitoring sensors 122, and the controller 104 executes operator selected functions and features according to known methods.

FIG. 2 illustrates a portion of an exemplary control interface 106 for the control system 100 of FIG. 1. The interface 106 includes a panel 202 that defines an interface area 204 for manipulation by a user to enter control commands and instructions for the device 102 (shown in FIG. 1). In one embodiment, the panel 202 may be mounted proximate the operative components 114-120 of the device 102, such as dispensing components of a vending machine or heating elements of an oven. In another embodiment, the panel 202 may be located in a remote location from the components 114-120 (such as for moving components of an industrial machine).

The interface area 204 includes touch sensitive areas 206, 208. While two touch sensitive areas 206 and 208 (corresponding to the touch sensors 107 and 109 in FIG. 1) are illustrated in FIG. 2, in alternative embodiments more or less touch sensitive areas 206 and 208 may be included in the interface area 204. Associated with each of the touch sensitive areas 206 and 208 are circuits or touch sensitive elements 210 and 212. The elements 210 and 212, and the controller 104 are configured to detect an actual touch, also referred to herein as a touch detection or touch result, at the associated touch sensitive areas 206 and 208, while avoiding false activation inputs which may be attributable to EMI and noise issues in the ambient environment. The touch sensitive elements 210 and 212 are controlled by and provide input to the controller 104 (shown in FIG. 1).

In an exemplary embodiment, the touch sensitive elements 210, 212 are capacitive touch sensors such as those described in U.S. Pat. No. 5,760,715, the disclosure of which is hereby incorporated by reference in its entirety. In alternative embodiments, the touch sensitive elements 210 and 212 are known membrane switch assemblies, infrared detectors, or other known tactile or touch switches familiar to those in the art. The touch sensitive areas 206 and 208 may be arranged in any desired orientation relative to one another within the confines of the panel 202, and greater or fewer touch sensitive areas may be employed in the panel 202 depending on the embodiment. In an alternative embodiment, the control system 100 may have more than one control panel 202, and each control panel 202 may have one or more interface areas 204 having one or more touch sensitive areas corresponding to touch sensitive elements.

In operation, a user touches, depresses or otherwise contacts, such as with a finger, the touch sensitive areas 206, 208 to enter a user command, instruction or input to the controller 104 (shown in FIG. 1). The controller 104, in turn, operates the applicable components 114-120 of the device 102 in accordance with the user input. When the touch sensor system of U.S. Pat. No. 5,760,715 is employed as the touch sensors 107 and 109, a touch may be detected when the touch sensitive elements 210, 212 associated with the respective touch sensitive areas 206, 208 issue a test pulse to earth ground and detects the return of the test pulse through the human user and through the touch sensitive area 206.

Generally, the controller 104 obtains a pre-test pulse baseline signal level (sometimes referred to herein as a current pre-test pulse baseline signal level, baseline signal level reading, current baseline signal level reading, baseline reading, and current baseline reading) from the control interface 106 for the touch sensitive elements 210, 212. The pre-test pulse baseline signal level is obtained from the touch sensitive elements 210, 212 before the element 210 sends a test pulse or pulse to earth ground. The controller 104 monitors a response to the pulse (pulse signal) by obtaining a post-test pulse signal level from the element 210 after the element 210 sends the pulse to earth ground. If the difference between the post-test pulse signal level and the pre-test pulse baseline signal level exceeds a current detect threshold value, the controller 104 senses a touch or detect at the touch sensitive area 206 and operates the associated device accordingly, subject to a verification by the controller which distinguishes between true and false control inputs.

The controller 104, in addition to other types of touch verification such as that described in U.S. Pat. No. 5,760,715, may implement a touch detection sequence for each test pulse in the manner described below to mitigate EMI, noise and interference issues in the ambient environment, and to secure accurate and reliable operation of the system over a wide range of operating conditions.

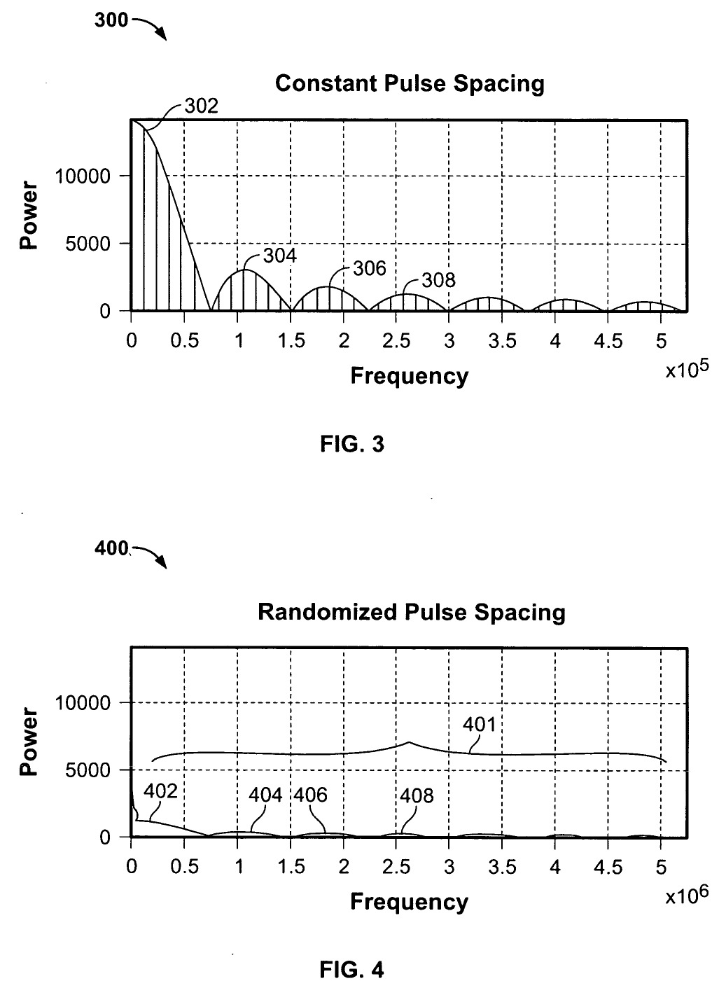

FIG. 3 is an exemplary graph 300 showing emitted power versus frequency when test pulses are generated at fixed or periodic intervals by the touch sensitive control system 100 of FIG. 1, and illustrates at least one of the disadvantages of such a system. As the graph 300 exhibits, the power emitted tends to be concentrated or peak at certain frequencies, e.g. peaks 302, 304, 306, and 308. The peaking of emitted energy or power at certain frequencies may cause the control system to exceed applicable government regulations, such as FCC part B certification regulations pertaining to conductive and radiated emissions for such devices. That is, the power emitted from the touch sensitive control system can itself exceed applicable regulations and can interfere with nearby electronic devices.

FIG. 4 is an exemplary graph 400 showing emitted power versus frequency according to an exemplary embodiment of the present invention wherein test pulses are generated at non-periodic intervals by the controller 104 of the touch sensitive control system 100 of FIG. 1. By way of example, a series of non-periodic test pulses may be generated by varying the intervals between pulses in a pseudo-random or randomized fashion. As shown in FIG. 4, the distribution of power with frequency is broadened or flattened 401 such that the power tends to be distributed more evenly over the frequency spectrum, without the large peaks 302, 304, 306, and 308 shown in FIG. 3 which may occur when periodic test pulses are employed. By substantially lowering the power peaks 302, 304, 306, and 308 of FIG. 3 to the corresponding flattened power peaks 402, 404, 406, and 408 of FIG. 4, emitted power associated with the non-periodic test pulses is significantly reduced. Consequently, the control system, by utilizing non-periodic test pulses as opposed to periodic ones, may satisfy applicable regulations and reduce potential interference from the control system 100 with respect to other electronic devices in the vicinity of the control system.

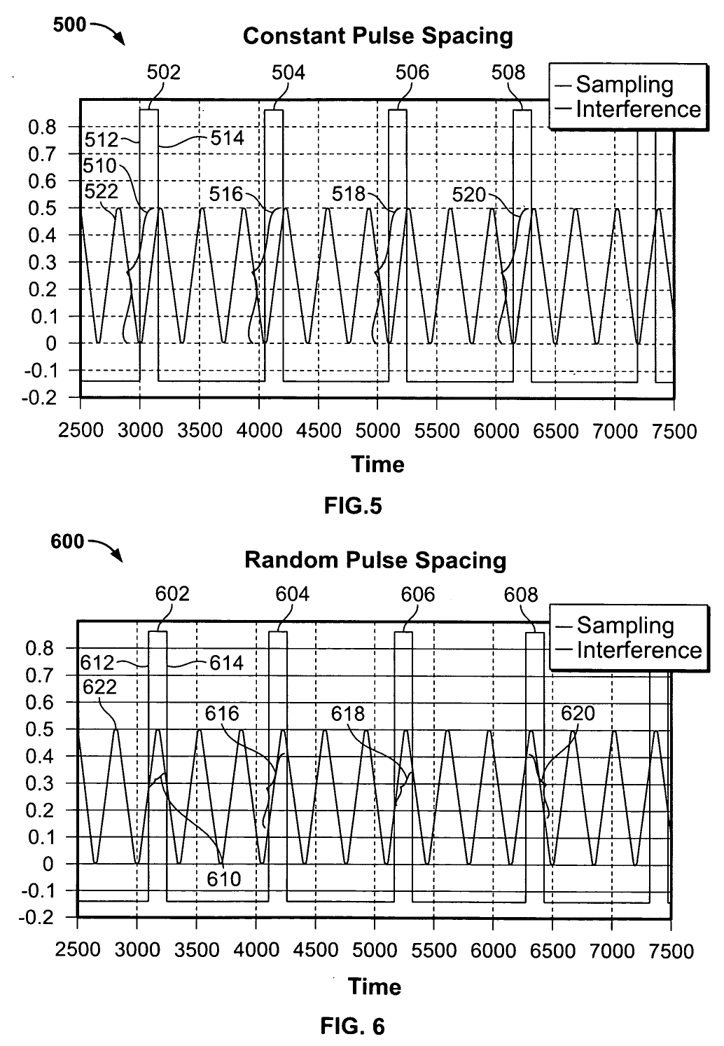

As illustrated in FIG. 5, the use of periodic test pulses is disadvantageous in another aspect beyond power emission issues. In particular, if periodic test pulses are used, the touch sensor system 100 may be susceptible to EMI interference from other electronic devices. More specifically, and as may be seen in FIG. 5, power produced by other electronic devices (e.g, a cell phone, a nearby appliance or other power emitting device) at a periodic frequency, or harmonics of the same periodic frequency that coincides with the periodicity of the test pulses may result in false touch detections.

FIG. 5 is a sampling graph 500 exemplifying the generation of test pulses with a constant pulse spacing, such as exemplary square pulses 502, 504, 506, and 508, and illustrates the potential for inaccurate touch detection to which the system is susceptible. For example, a baseline sampling reading may be taken at a touch key 206 before the test pulse is generated, i.e., at the rising edge of the pulse 502. A post-pulse sampling 514 may be taken at the key 206 after generation of the pulse 502, i.e., at the falling edge of pulse 502. According to the general control scheme described above, if a sampling difference 510 (e.g. the post-pulse sampling 514 minus the baseline sampling 512) exceeds a current positive detect threshold, a touch or detect is sensed at the touch key 206.

As FIG. 5 illustrates however, synchronous noise 522 in the ambient environment of the control system 100 may have unexpected affects on the system 100. As shown in FIG. 5, the noise 522 has a periodicity which coincides with the periodicity of the generated test pulses 502-508. At each of the pulses 502, 504, 506 and 508, the baseline sampling starts low, e.g. at value 0 for the sampling 512, and the post-pulse sampling ends high, e.g., at value 0.5 for the sampling 514. The sampling difference 510 for test pulse 502 therefore has a value of 0.5. If, for example, the current detect threshold for the system is set at value below 0.5 (e.g., 0.3), the value 0.5 of the sampling difference 510 is greater than the current detect threshold 0.3, and a touch will be detected at the key 206 for the pulse 502.

Likewise, due to the common periodicity of the EMI 522, the sampling differences 516, 518, and 520 for the corresponding pulses 504, 506, and 508 will also have a value of 0.5, and will also be detected as touches. Thus, because of the coincident periodicity of the synchronous noise, the touches will continue to be detected by the controller for a sustained period of time. That is, the detected touches, even though clearly false, will eventually be verified by the system using conventional, time-based methods for verification, such as that described in the U.S. Pat. No. 5,760,715.

FIG. 6 is a sampling graph 600 exemplifying test pulses generated by the controller with non-periodic pulse spacing according to the present invention, such as exemplary square pulses 602, 604, 606, and 608. A pseudo-random or random jitter may be added to the spacing of pulses 502-508 of FIG. 5 to obtain a pseudo-random or random spacing between the pulses 602-608 of FIG. 6. A baseline sampling 612 is taken at a touch key, e.g. key 206, before the test pulse is generated at the rising edge of the pulse 602. Thereafter, a post-pulse sampling 614 is taken at the key 206 after generation of the pulse 602 at the falling edge of pulse 602. Although a periodic noise 622 is present, and unlike the system having periodic test pulses shown in FIG. 5, the noise 622 may lead to a touch detection for one or more of the test pulses, but because of the non-periodic test pulse spacing the detected touch will not likely be verified, and the detected touch will consequently be ignored.

As shown in FIG. 6, because of the non-periodic test pulse spacing, the sampling differences of successive test pulses will tend to vary, despite the periodicity of the noise 622, and thus the test pulses are unlikely to pass time-based verification procedures, such as that described in U.S. Pat. No. 5,760,715.

For example, and as illustrated in FIG. 6, a sampling difference 610 for the first test pulse 602 is a small positive value. A sampling difference 616 for the next, or second, test pulse 604 is a large positive difference and may be sufficient to cause a detect/touch to be sensed at the key 206. A sampling difference 618 for the third test pulse 606, however, is a small positive value. A sampling difference 620 for the fourth test pulse 608 is a large negative value. Thus, although a detect or touch may be registered for the sampling difference 616 for pulse 604, the detect or touch is not verified at the successive pulses 606 and 608. By varying the pulse spacing between pulses to be non-periodic, the chance of verifying a false touch at a touch key 206 due to a periodic noise 622 or other periodic interference is largely reduced, if not entirely eliminated, especially as the number of successive pulses in the verification procedure increases.

While non-periodic test pulse spacing will substantially avoid false touch detection attributable to synchronous noise and interference, the control system may nonetheless be susceptible to other types of noise and interference (e.g., asynchronous or random noise events). The controller 104 is further configured to address these issues as described below.

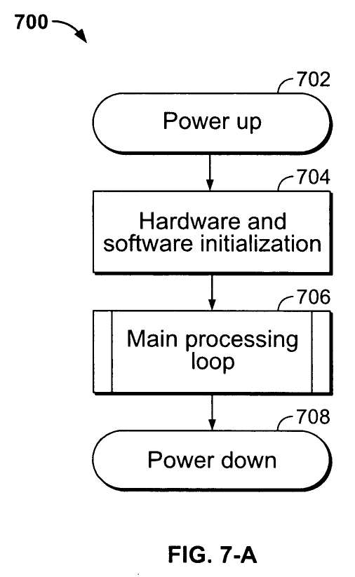

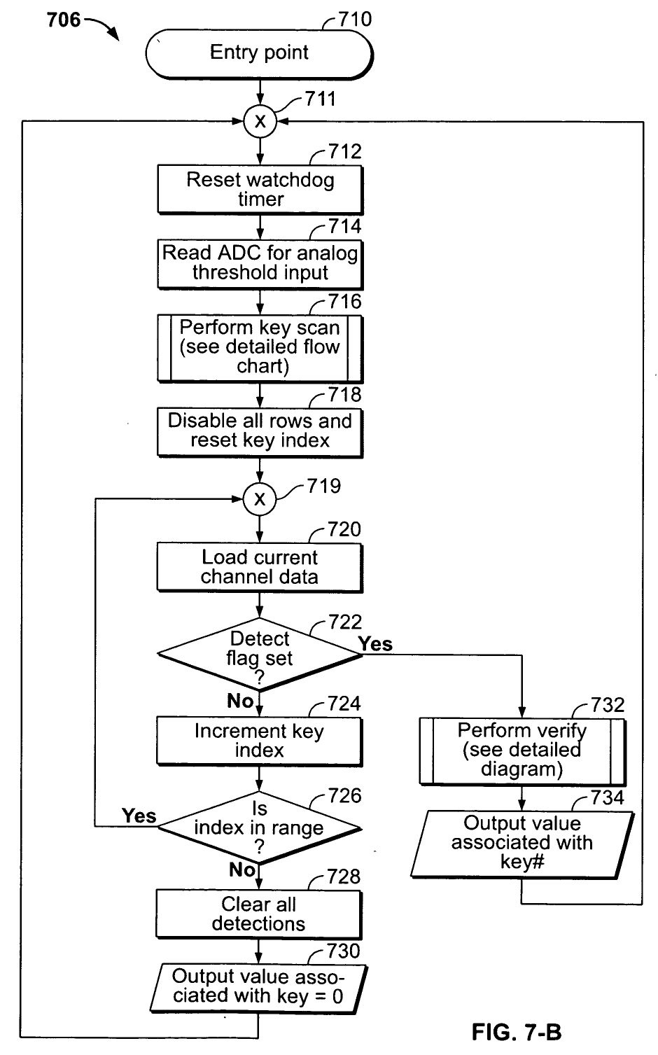

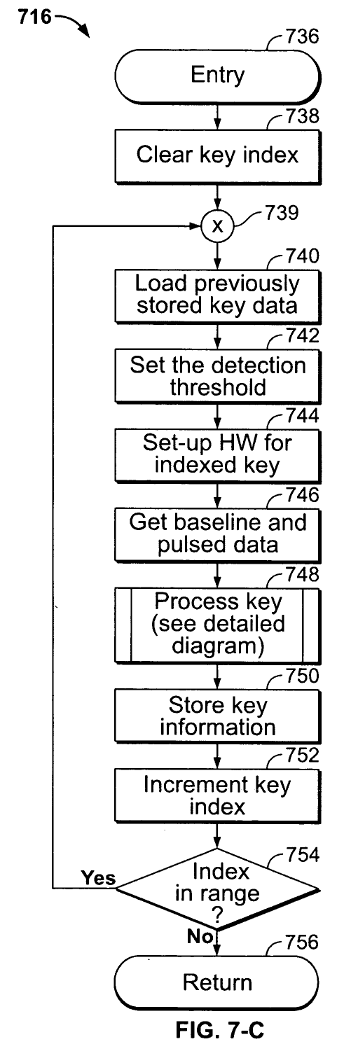

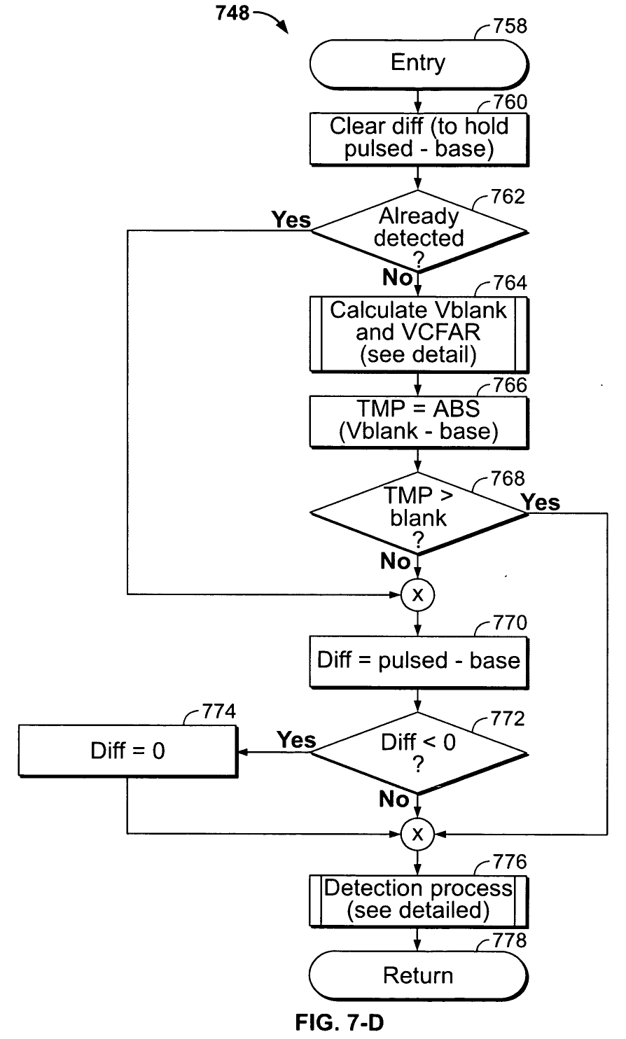

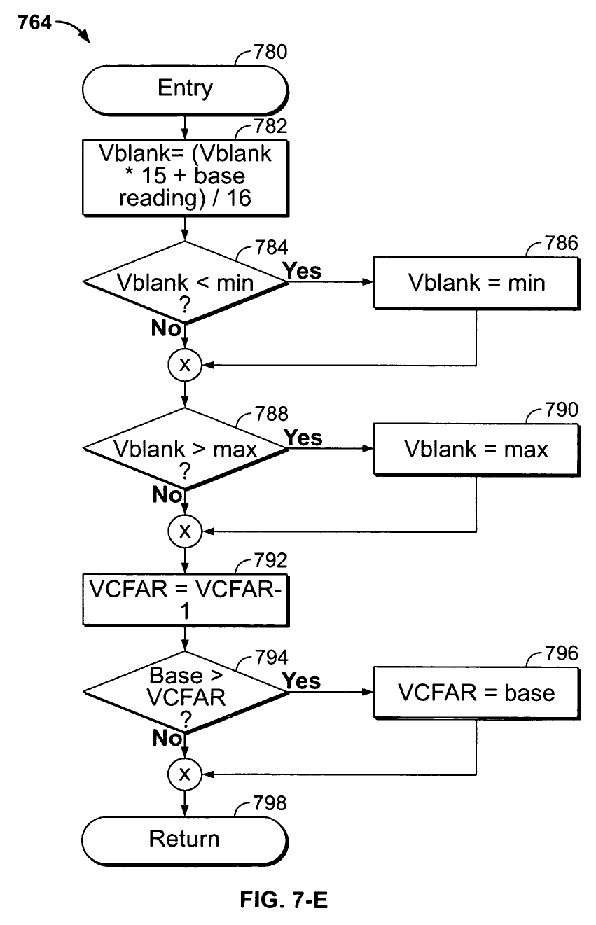

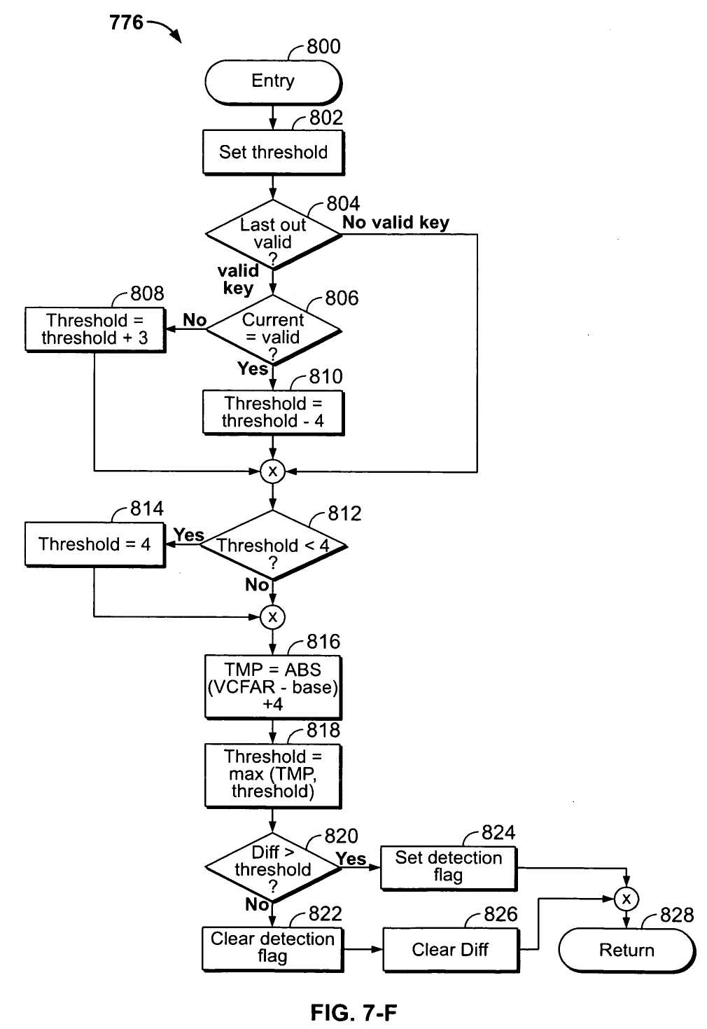

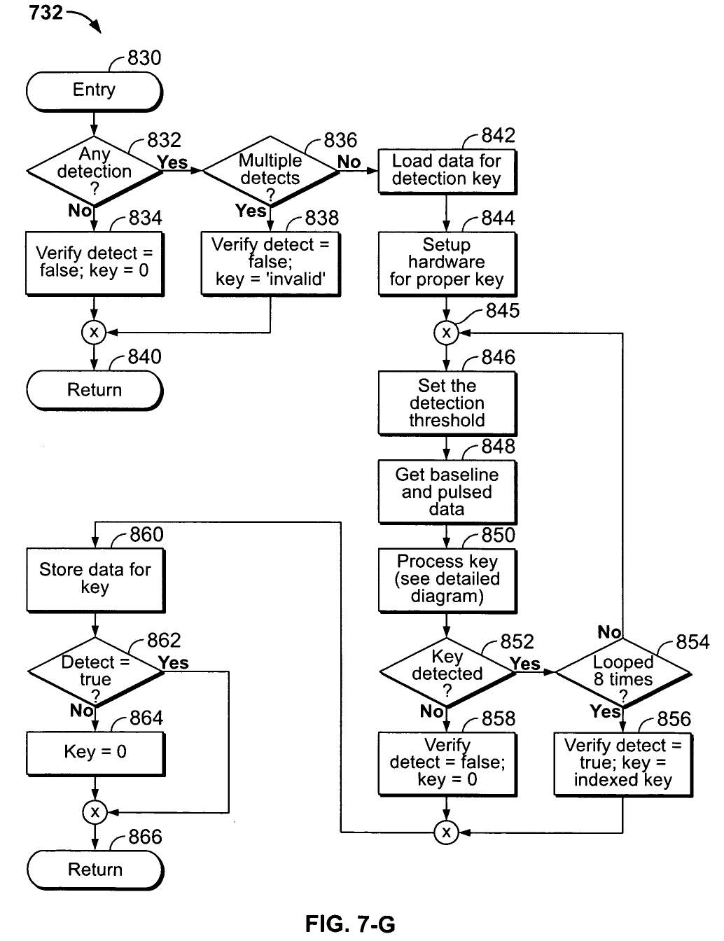

FIG. 7 is a flowchart describing an exemplary control algorithm 700 which employs a processing blanking technique and a false alarm rate constant (vcfar) technique, each explained in detail below, to compensate for non-synchronous noise and interference events which may otherwise undesirably affect the touch sensitive control system 100 (shown in FIG. 1). The use of processing blanking and vcfar, in addition to the non-periodic or randomized test pulse spacing described above, further avoids false detects/touches at the touch control system 100 due to noise and interference from the operation of nearby devices. The algorithm 700 may be executed, for example, by the controller 104 of FIG. 1 to distinguish true and false inputs from the control interface 106, and more specifically from the touch sensitive areas/keys 206 and 208 (FIG. 2). By distinguishing between true and false control inputs, inadvertent actuation of the components 114-120 (FIG. 1) of the device 102 is prevented and only properly entered control input instructions are recognized to operate the device 102.

In FIG. 7-A, at 702 the control system 100 (shown in FIG. 1) is powered on, and hardware and software are initialized at 704. The controller enters 706 a main processing loop and remains within the main processing loop until at 708 the system 100 is powered down.

The main processing loop performed at 706 is illustrated in FIG. 7-B. At 710, the controller enters the main processing loop subroutine, and at 711, the controller enters the main processing loop. At 712, a watchdog timer is reset. If the watchdog timer should time out before being reset at 712, a watchdog timer interrupt occurs and directs processing to 704 in FIG. 7-A, and the hardware and software of system 100 are re-initialized. At 714, predetermined detect threshold information for the touch sensors 107 and 109 (FIG. 1) is read by the controller 104 from the A/D converter (ACD) 111. Alternatively, predetermined detect thresholds could be stored and obtained from controller memory 110. At 716, a subroutine is called to perform a scan of all the touch sensor keys 206 and 208 of the touch panel 202 (FIG. 2). The scan will cause a pulse to be generated at each key 206 and 208 in order to detect a touch at each of the keys.

The scan-of-touch-keys subroutine for the controller is shown in FIG. 7-C. At 736, the controller enters the scan-of-touch-keys subroutine to determine or sense touches at the touch keys 206 and 208. At 738, the key index is reset to point to the first touch key (e.g., key 206) to be processed. A loop is entered at 739 to process a touch key, namely the currently indexed touch key 206. At 740, the previously stored data (e.g. in memory 110 of FIG. 1) for the current touch key 206 is retrieved. Data memory is initialized for each key during initialization at 704 (FIG. 7-A). The retrieved data for the current touch key 206 may include parameter values.

In an exemplary embodiment, one of the parameter values retrieved is a moving average of pre-test pulse baseline signal levels, also herein referred to as a moving average of baseline signals or moving average of baseline signal level readings. Other parameter values retrieved include a predetermined blanking threshold, a predetermined baseline reference value, also known herein as a vcfar value, a vcfar constant, and a predetermined detect threshold. The parameter values are obtained for a given key, e.g., key 206, and are discussed further below.

At 742 the predetermined detect threshold is set for the current key 206 and pulse hardware is set up at 744 to generate a test pulse for the key 206. At 746 a pre-test pulse baseline reading is taken, the test pulse generated, and a post-test pulse signal reading taken. At 748, a subroutine is called to continue processing for the key 206.

The continue-processing-touch-key subroutine is shown in FIG. 7-D. At 758, the controller enters the continue-processing-touch-key subroutine to prepare to determine whether a touch is present at the key 206. A pre-post test pulse difference variable for holding the difference between the post-test pulse signal level and the pre-test pulse baseline signal level is initialized to zero at 760. At 762 a check is performed for whether a touch is already detected. A touch may already be detected if the continue-processing-touch-key subroutine was called from a verification subroutine instead of from the subroutine processing at 748. If a first touch detection is not pending for the key 206, and thus the subroutine entered at 758 is called to detect a first touch and not to verify a first touch, at 764 a subroutine is called or performed to determine the moving average and the vcfar value.

The calculate-Vblank-and-vcfar subroutine is shown in FIG. 7-E. At 780, the subroutine is entered. At 782 the moving average of baseline signal levels is computed by averaging in the current pre-test pulse baseline signal level acquired previously at 746 (FIG. 7-C). The new moving average is stored in variable Vblank. At 784, processing determines whether the new moving average is less than a minimum value, and if so, processing at 786 sets the new moving average Vblank to the minimum allowed value. At 788, the controller determines whether the new moving average is greater than a maximum value, and if so, processing at 790 sets the new moving average Vblank to the maximum allowed value. The new moving average Vblank will be used in algorithm 700 to determine whether processing blanking of a touch at the current key 206 is to occur as explained below. At 792 the current vcfar value is decremented by 1, and if at 794 the resulting vcfar value is less than the current pre-test pulse baseline signal level, the value of vcfar is set at 796 to the current pre-test pulse baseline signal level. Processing at 798 returns from the calculate-Vblank-and-vcfar subroutine to FIG. 7-D, specifically to 766. At 766, a TMP variable (a temporary or temp value associated with the current pulse) is calculated for use in deciding the application of a processing blanking technique.

The vcfar value for touch key 206 follows or traces the noise threshold or noise floor for the touch key 206 over time, and reflects a current level of ambient noise present when the test pulses are generated. If the current pre-test pulse baseline signal level is greater than the current vcfar value, then noise is present, and the noise floor is raised by setting vcfar to the current-pre-test pulse baseline signal level at 796. As such, the sensitivity of the control interface is self-adjusting as the noise level increases, and the threshold for touch detection is raised accordingly as noise events occur. Absent such adjustment, a propensity of the system to falsely detect and verify touches would increase as the noise level increases because the noise tends to increase the pre-test pulse baseline signal levels. The vcfar value also compensates for operating bias and temperature effects on sensitive electronic components which could increase a propensity of the system to falsely detect and verify touches by raising the pre-test baseline signal levels.

From one pulse to the next, the vcfar value decays. In the embodiment described, the vcfar value at 792 linearly decays by subtracting 1 from the vcfar value. In alternative embodiments, the decay may be other than linear, e.g. the decay may be exponential or logarithmic. By decaying the vcfar value, the sensitivity of the control interface is self-adjusting as the noise level decreases, and the system touch detection threshold eventually returns to a predetermined threshold value in the absence of any noise. Thus, as the noise subsides, so does the vcfar adjustment, and the behavior of the system returns to default conditions until a noise event reoccurs.

By continually adjusting the vcfar value to follow or ride on the noise threshold or noise floor, the vcfar value for the key 206 may be used to adjust the sensitivity for processing a touch at the key 206. For example, at any given time the current detect threshold retrieved by the controller may be set to a predetermined detect threshold value. However, to compensate for noise conditions, the current detect threshold value may temporarily be set (for processing of a touch during the pulse associated with the current touch key 206) by the controller to a temporary value which is higher than the threshold value. More specifically, in an exemplary embodiment, the temporary value may be set equal to the sum of the vcfar constant and an absolute value of a difference between the vcfar and the current pre-test pulse baseline signal level.

When the current calculated temporary value is greater than the predetermined detect threshold value for the touch key 206, the temporary value is used for the current detect threshold instead of the predetermined detect threshold. When the pre-post test pulse difference is greater than the current detect threshold, a touch is sensed at the key 206. In using the temporary value temporarily for the detect threshold, the pre-post test pulse difference accounts for the current level of ambient noise present at the key 206 which otherwise affects the accuracy of the control. By strategically selecting the value of the vcfar constant, a probability of false alarms or false detects may be controlled. In an exemplary embodiment, vcfar constant is set to 4, and the false alarm rate (false detects) is close to zero.

At 766, a TMP variable is set to an absolute value of a difference between the current Vblank value (the current moving average) and the pre-test pulse baseline signal level. The TMP value denotes the change in the current pre-test pulse baseline signal level from the moving average of baseline signals. If at 768 the TMP value is found to be greater than the predetermined blanking threshold, processing is directed at 776 to perform the detection-process subroutine. Note that at 768, if the TMP value, namely the change in the current pre-test pulse baseline signal level from the moving average of baseline signals, is greater than the predetermined blanking threshold, the pre-post difference is left at the initialized value of zero, effectively ignoring the reading. A value of zero for the pre-post difference indicates to detection processing at 776 that no detect or touch should be registered for the current touch key 206. Since a pre-post difference equal to zero can never be greater than a positive detect threshold value, a detect will not be registered for the current touch key 206 by processing at 776, and processing blanking is established.

Processing blanking ignores any calculation resulting in the detection of a key touch when the change in the current pre-test pulse baseline signal level from the moving average of baseline signals is too large, namely is greater than the predetermined blanking threshold. Thus, processing blanking prevents the controller from reacting or responding to extreme or unusual events outside the normal operating range of the system, and the controller, because of the processing blanking, will not respond until such events subside. In a further embodiment, when processing blanking occurs (TMP>predetermined blanking threshold at 768), the occurrence of processing blanking and related data may be stored in memory 110 (FIG. 1) for diagnostic purposes. Such data may be used for diagnostic and troubleshooting purposes, e.g., to discover the cause of the interference noise and/or how to prevent such noise interference from occurring.

If the TMP value is not greater than the predetermined blanking threshold at 768, at 770 the pre-post test pulse difference, herein also referred to as the pre-post difference, is set to the post-test pulse signal level minus the pre-test pulse baseline signal level. At 772, a sanity check is made on the pre-post difference. If the pre-post difference is less than zero, then at 774 the pre-post difference is made equal to zero.

At 776, the detection-process subroutine for detecting a touch at key 206 is called or performed. The detection-process subroutine is provided in FIG. 7-F. At 800, the controller enters the detection-process subroutine to prepare to determine whether a touch is present at the key 206. The controller at 802-814 adjusts the predetermined threshold value for the current pulse. At 816, the TMP variable is set equal to the sum of the vcfar constant (in the illustrated embodiment, the constant is chosen as 4) and an absolute value of a difference between the vcfar and the current pre-test pulse baseline signal level. At 818, the current detect threshold is set to the maximum of the TMP value and the adjusted predetermined threshold value.

At 820, a decision is made as to whether a touch is sensed. If at 820, the pre-post difference is greater than the current detect threshold, a touch is sensed, and at 824 a detection flag is set. If at 820, the pre-post difference is not greater than the current detect threshold, a touch is not sensed. At 822 the detection flag is reset. At 826, the pre-post difference is set to zero. At 828, processing then returns from the detection-process subroutine to 778 of FIG. 7-D.

At 778, the controller returns from the continue-processing-touch-key subroutine to 750 of FIG. 7-C. At 750, current data calculated for the current touch key 206 is stored, e.g. in memory 110 (FIG. 1), including the current parameter values for the moving average of baseline signals and the vcfar value. At 752, the key index is updated to point to a next touch key, e.g. now points to the touch key 208. If at 754 the incremented key index is in range (e.g. points to a valid next touch key), processing returns to 739, and the loop at 739 is again executed to process the next touch key, e.g. touch key 208. When all touch keys have been processed by the loop at 739, at 754 the key index is found out of range, and processing is returned at 756 from the scan-of-touch-keys subroutine to FIG. 7-B at 718.

At 718, the key index is set to point to a first touch key, e.g. touch key 206, in preparation for entering a loop at 719. At 720, the scan data for the currently indexed touch key 206 is obtained. If at 722 the detect flag is set for the currently indexed touch key 206, processing is directed to calling the perform-verify subroutine at 732 to verify the detected touch for the currently indexed touch key 206. If the detect flag is not set at 722, processing at 724 increments the key index to point to the next touch key, e.g. touch key 208. If at 726 the key index is in range, e.g. points to a valid touch key, processing returns to the loop at 719 to process the currently indexed touch key, e.g. touch key 208. If at 726 the key index is not in range, which indicates all touch keys processed, processing is directed to 728. Processing at 728 clears all detected touches for the touch keys. At 730, processing outputs a message or indicator associated with no errors (key=0) to the user display 108 (FIG. 1). Processing then returns to the top of the main processing loop at 711. If at 722 the detect flag is set for the currently indexed touch key, the perform-verify subroutine is called at 732, and processing enters the entry point at 830 in FIG. 7-G to perform verification of the detected key touch.

The perform-verify subroutine is provided in FIG. 7-G. At 830, processing enters the perform-verify subroutine. If at 832 a touch detect is not present, at 834 a verify-detect flag is set to false and a key flag is set to zero (indicate no errors for output message). Processing at 840 returns from the perform-verify subroutine to 734 in FIG. 7-B. If at 832 a touch detect is present, then a check at 836 is made for multiple touch keys found with detects present. If more than one touch key is flagged with a detect, then at 838 the verify-detect flag is set to false, and the key flag is set to invalid to indicate an invalid input (namely multiple touch keys touched at the same time) by the user. From 838, the controller at 840 returns from the perform-verify subroutine to 734 in FIG. 7-B. If a touch key is flagged for a touch /detect at 832 and at 836 only one touch key is found flagged for a detect/touch, processing at 842 retrieves the stored key data for the currently indexed touch key 206.

At 844 hardware is set up for generating test pulses for the currently indexed touch key 206. At 845 a loop is entered and at 846 the predetermined detect threshold is obtained. At 848 a pre-test pulse baseline reading is taken, the test pulse generated, and a post-test pulse signal reading taken. At 850, the continue-processing-touch-key subroutine is called with the outcome from the subroutine return at 778 (FIG. 7-D) setting or resetting a detect flag. Note that at 762 (FIG. 7-D), the already detected test is true since a first touch has already been detected. If at 852 (FIG. 7-G) the detect flag is set from the continue-processing-touch-key subroutine call, processing is directed to 854.

At 854, a test is performed for eight consecutive detects (eight iterations of the loop at 845) being accumulated for the currently indexed touch key 206. In alternative embodiments, a number less than or greater than eight may be used for the accumulated consecutive detects. If at 854, eight consecutive detects have been accumulated (eight iterations of the loop at 845), processing is directed to 856, else back to the loop at 845. At 856 the verify-detect flag is set true, and the key flag is set to the indexed key for use in outputting an indicator at the user display 108. Processing is then directed to 860. If eight consecutive touches have not been found, at 858 the verify-detect flag is set to false, and the key flag to 0. Processing then is directed to 860.

At 860, current data for the key is stored and a check is made at 862 for the verify-detect flag value. If the verify-detect flag is set to true, processing at 866 returns from the perform-verify subroutine to 734 in FIG. 7-B. If the verify-detect flag is set to false, processing at 864 sets the key flag to 0 and at 866 returns to 734 in FIG. 7-B. At 734 in FIG. 7-B, an indicator or message associated with the key flag value is output to the user display 108, and the controller returns to the beg inning of the main processing loop at 711.

In summary, the processing of the main processing loop at 711 performs a scan at 716 of all touch keys for detects or touches at any of the touch keys. If a detect is found at 722, e.g. a detect flag is set for the currently indexed touch key, verification is performed at 732 to verify some number of consecutive detects or touches (e.g. eight for the embodiment described) at the currently indexed touch key. With the needed number of consecutive detects verified, the touch key is thus verified for the sensed touch. The controller 104 (FIG. 1) performs the needed associated processing (not shown in the algorithm 700) for the verified touch detection.

The described embodiment of the algorithm 700 can readily be adapted by those in the art with appropriate modification for use in various devices to provide an appropriate safeguard against inadvertent actuation or operation of the device components 114-120 of device 102 (FIG. 1). It is believed that the methodology of the above-described control system could be implemented in the controller programming without further explanation.

A touch sensitive control system is therefore provided having a controller which is programmed to compensate for various types of noise that may otherwise lead to false touch detection. By utilizing non-periodic test pulse spacing, the vcfar technique to adjust the system sensitivity to varying noise levels, and the processing blanking technique described above, in combination with the other aspects of the control algorithm described above, a highly accurate and reliable control system is achieved that is substantially unaffected by noise and interference events to which conventional touch control systems are susceptible.

While the invention has been described in terms of various specific embodiments, those skilled in the art will recognize that the invention can be practiced with modification within the spirit and scope of the claims.

What is claimed is:

1. A control system for controlling a device, said control system comprising:
a touch sensitive interface; and
a controller configured to communicate with said touch sensitive interface and to detect user manipulation of said touch sensitive interface with a series of non-periodic test pulses and monitored responses thereto, thereby avoiding inaccurate touch detection attributable to synchronous noise in an ambient environment of said control system.

2. A control system in accordance with claim 1 wherein said controller is configured, for each test pulse, to:
obtain a pre-test pulse baseline signal level from said touch sensitive interface;
obtain a post-test pulse signal level from said touch sensitive interface;
compare the post-test pulse signal level to the pre-test pulse baseline signal level; and
if a difference between the post-test pulse signal level and the pre-test pulse baseline signal level exceeds a current detect threshold, to respond to said touch sensitive interface and to operate the device accordingly.

3. A control system in accordance with claim 2 wherein said controller is further configured to ignore said touch sensitive interface and fail to operate the device when the difference between the post-test pulse signal level and the pre-test pulse baseline signal level is less than the current detect threshold.

4. A control system in accordance with claim 1, wherein said controller is further configured to determine a moving average of pre-test pulse baseline signal levels over time, and for each test pulse, said controller is further configured to compare a current pre-test pulse baseline signal level to the moving average of baseline signals, and to ignore the monitored response to the current test pulse when a difference between said current pre-test pulse baseline signal level and the moving average of baseline signals exceeds a predetermined blanking threshold.

5. A control system in accordance with claim 2, wherein said controller is further configured to, for each test pulse, compare a current pre-test pulse baseline signal level to a predetermined baseline reference value, and if said current pre-test pulse baseline signal level exceeds said predetermined baseline reference value, to set said predetermined baseline reference value at least equal to the current pre-test pulse baseline signal level.

6. A control system in accordance with claim 5, wherein said controller is further configured to decay the predetermined baseline reference value before the comparing of the current pre-test pulse baseline signal level to the predetermined baseline reference value.

7. A control system in accordance with claim 6, wherein said controller is further configured to use for the current detect threshold, a temporary value instead of a predetermined detect threshold when said temporary value is greater than the predetermined detect threshold, said temporary value being equal to a constant added to an absolute value of a difference between the predetermined baseline reference value and the current pre-test pulse baseline signal level.

8. A control system in accordance with claim 1 wherein said series of non-periodic test pulses are generated by the controller with a pseudo random or random jitter to periodic pulses.

9. A control system in accordance with claim 1, wherein said touch sensitive interface includes a capacitive touch sensor.

10. A control system for controlling a device, said control system comprising:
a touch sensitive interface; and
a controller configured to pulse said touch sensitive interface at randomized pulse spacing and conduct a touch detection sequence responsive to said pulses, thereby avoiding inaccurate touch detection attributable to synchronous noise in an ambient environment of said control system.

11. A control system in accordance with claim 10 wherein, at each touch detection sequence, said controller is further configured to:
obtain a pre-test pulse baseline signal level from said touch sensitive interface;
send a test pulse signal to said touch sensitive interface;
sense a post-test pulse signal level from said touch sensitive interface;
compare the post-test pulse signal level to the pre-test pulse baseline signal level; and
if a difference between the post-test pulse signal level and the pre-test pulse baseline signal level exceeds a current detect threshold, to respond to said touch sensitive interface and to operate the device accordingly.

12. A control system in accordance with claim 11 wherein the controller is further configured to ignore said touch sensitive interface and fail to operate the device when the difference between the post-test pulse signal level and the pre-test pulse baseline signal level is less than the current detect threshold.

13. A control system in accordance with claim 11, wherein said controller is further configured to determine a moving average of pre-test pulse baseline signal levels over time, and at each touch detection sequence, said controller is further configured to compare a current pre-test pulse baseline signal level to the moving average of baseline signal levels, and if the difference between said current pre-test pulse baseline signal level and said moving average of baseline signals exceeds a predetermined blanking threshold, to ignore a touch detect for the current touch detection sequence and begin another touch detection sequence.

14. A control system in accordance with claim 11, wherein said controller is further configured, at each touch detection sequence, to compare a current pre-test pulse baseline signal level to a predetermined baseline reference value, and if said current pre-test pulse baseline signal level exceeds said predetermined baseline reference value, to set the predetermined baseline reference value at least equal to the current pre-test pulse baseline signal level.

15. A control system in accordance with claim 14, wherein said controller is further configured to reduce the predetermined baseline reference value before the comparing of the current pre-test pulse baseline signal level to the predetermined baseline reference value.

16. A control system in accordance with claim 15, wherein said controller is further configured to use for the current detect threshold for the current touch detection sequence, a temporary value instead of a predetermined detect threshold when said temporary value is greater than the predetermined detect threshold, said temporary value being equal to a constant added to an absolute value of a difference between the predetermined baseline reference value and the current pre-test pulse baseline signal level.

17. A control system in accordance with claim 10 wherein said randomized pulses are generated by the controller with a pseudo random or random jitter to periodic pulses.

18. A control system in accordance with claim 10, wherein said touch sensitive interface includes a capacitive touch sensor.

19. A control system in accordance with claim 10, wherein said controller comprises a microprocessor and a memory, said controller further configured to record touch detection sequence information in said memory for diagnostic purposes.

20. A control system for controlling a device, said control system comprising:
a touch sensitive interface including at least one capacitive touch sensor configured to complete a circuit through earth ground when touched by a user; and
a controller configured to pulse said touch sensitive interface and conduct a touch detection sequence responsive to said pulses, said pulses being randomized to avoid inaccurate touch detection attributable to synchronous noise in an ambient environment of said control system, and said controller further configured to compare a pre-test pulse baseline signal level to a post-test pulse signal level at each touch detection sequence to validate or invalidate a detected touch based upon a difference between pre and post-test pulse signal levels and a current detect threshold.
